(19) United States
(12) Patent Application Publication
(10) Pub. No.: US 2020/0317971 A1
(43) Pub. Date: Oct. 8, 2020

(54) Thermally Conductive Polyurethane Adhesive with Exceptional Combination of Mechanical Properties

(71) Applicant: Henkel AG & Co. KGaA, Duesseldorf (DE)

(72) Inventors: Thomas Zoeller, Essen (DE); Nicole Schlingloff, Duesseldorf (DE); Thomas Engels, Duesseldorf (DE); Eric Schmitz, Duesseldorf (DE)

(21) Appl. No.: 16/904,397

(22) Filed: Jun. 17, 2020

Related U.S. Application Data
(63) Continuation of application No. PCT/EP2018/083000, filed on Nov. 29, 2018.

(30) Foreign Application Priority Data
Dec. 20, 2017 (EP) 17209083.9

(51) Int. Cl. C09J 175/08

(52) U.S. Cl. CPC C09J 175/08; C09J 2475/00; C08K 2003/385; C09J 2205/102; C09J 2203/10; C09J 2400/16

(57) ABSTRACT

The present invention relates to a thermally conductive adhesive composition having excellent mechanical properties and a method of manufacturing the same. Further, the present invention relates to method of manufacturing an article comprising the thermally conductive adhesive composition and articles obtainable by the described method.

The present invention relates to a thermally conductive adhesive composition having excellent mechanical properties and a method of manufacturing the same. Further, the present invention relates to method of manufacturing an article comprising the thermally conductive adhesive composition and articles obtainable by the described method.

Adhesive which are thermally conductive are employed in several applications where a component has to be fixed upon a structure and where heat has to be deflected from the component. Many applications are therefore in the field of electronics where excess thermal energy generated by the electronic components has to be expelled.

In the course of the ongoing development in the field of electromobility and the use of electric powered vehicles, in particular cars and trucks, it was found that materials with complex requirement specifications are needed. Especially fixing the energy storage device, the “heart” of the electric powered vehicle, has proven to be a challenge, as any adhesives used need to exhibit a thermal conductivity to, for example, deflect any heat generated during charging of the energy storage device while at the same time possessing mechanical and adhesive properties that allow for a safe and long-lasting assembly. In addition, the adhesive used has to have a high isolating resistance to avoid any overflow of electricity from the storage device to the body of the vehicle so as not to endanger any of the passengers.

US 2004/0125565 discloses a thermal interface material comprising a polymer matrix having a thermally conductive first face and an opposite thermally conductive second face and a plurality of carbon nanocapsules incorporated in the polymer matrix.

WO 2009/147117 describes a method of adhering a first component to a second component, comprising the steps of adhering the two components together using a composition comprising a polyurethane and from 20 to 80 wt.-% of a particulate metal, metal salt or metal alloy filler, wherein the polyurethane is a reaction product of a first polyol having a molecular weight of less than 1000, a second polyol having a molecular weight of from 1500 to 10000, at least one polyisocyanate, and at least one curing agent and wherein the particulate metal, metal salt or metal alloy filler has a thermal conductivity of at least 150 W/mK, and curing the composition.

WO 2016/139221 relates to hot melt adhesives with improved thermal conductivity comprising at least one (co)polymer binder and combination of different fillers. The fillers are a mixture of fillers selected from thermally conductive metal components having an aspect ratio of 1 to 10 and flaky metals having an aspect ratio of more than 10.

The solutions presented in the prior art suffer from the drawbacks that usually an increase in thermal conductivity adversely effects the mechanical properties such as tensile modulus, tensile elongation and strength and the isolating resistance.

It is therefore the object of the present invention to overcome the above-mentioned drawbacks by providing an adhesive composition which favorably combines the above-mentioned properties, and which is suitable for use in electric powered vehicles.

It was surprisingly found that the object of the invention can be solved by combining different filler materials exhibiting different thermal conductivities and incorporating such a mixture of fillers into an adhesive composition.

A first object of the invention is therefore an adhesive composition comprising a first component A and a second component B, wherein component A comprises:
a-1) at least on polyol having a molecular weight Mₙ of 700 to 12000 g/mol;
a-2) at least one chain extender having a molecular weight Mₙ of 60 to 600 g/mol;
a-3) at least a first thermally conductive filler A1 exhibiting a thermal conductivity of no more than 50 W/mK; and
a-4) at least a second thermally conductive filler A2 exhibiting a thermal conductivity of at least 80 W/mK; and
   wherein component B comprises at least on NCO-terminated compound.

The thermal conductivity is determined according to ISO 22007 (hot disk).

If reference is made herein to a molecular weight of a polymer, this reference refers to the average number weight Mₙ, unless stated otherwise. The number average molecular weight Mₙ of a polymer can, for example, be determined by gel permeation chromatography (GPC) according to DIN 55674 with THF as the eluent. If not stated otherwise, all given molecular weights are those determined by GPC, calibrated with polystyrene standards. The average molecular weight M_{w} can also be determined by GPC, as described for Mₙ.

### Component A

Component A of the inventive adhesive composition comprises a polyol of a specific molecular weight, a chain extender having a specific molecular weight and at least two fillers A1 and A2 which differ with regard to their thermal conductivity.

In a preferred embodiment of the present invention, the polyol is a polyol having a molecular weight Mₙ of 700 to 12000 g/mol, in particular 1000 to 12000 g/mol. Even more preferably, the polyol is a polyether polyol, preferably a polyether diol which preferably comprises primary hydroxyl groups or a mixture of primary and secondary hydroxyl groups. Examples of suitable polyether polyols are polyoxyalkylene polyols such as polyethylene glycol, polypropylene glycol, polytetramethyl glycol and polybutyl glycol. Also, homopolymers or copolymers of the listed polyoxyalkylene polyols as well as mixtures thereof are suitable for the purpose of the present invention. Particularly suitable copolymers are those comprising an adduct of a compound selected from the group consisting of ethylene glycol, propylene glycol, diethylene glycol, propylene glycol, triethylene glycol, 2-ethylhexandiol-1,3-glycerine, trimethylolpropane, trimethylolethane, tris(hydroxyphenyl)propane, triethanolamine and triisopropylamine with at least one compound selected from the group consisting of ethylene oxide, propylene oxide and butylene oxide.

In an especially preferred embodiment, the polyether polyol is an ethylene glycol end-capped polyethylene glycol/polypropylene glycol diol.

In a preferred embodiment of the invention, the polyether polyol is present in component A in an amount of at least 10 wt.-%, preferably 10 wt.-% to 35 wt.-%, based on the total weight of component A. It was surprisingly found that the adhesive properties of the adhesive composition can be improved if the amount of polyether polyol is within in the claimed ranges.

The inventive adhesive composition unexpectedly showed the desired combination of properties, in particular a high thermal conductivity at high volume resistivity in combination with excellent mechanical properties. It was surprisingly found that this set of properties can be achieved by combining filler exhibiting different thermal conductivities with polymer compounds having specific molecular weights.

The first filler, filler A1 exhibits a thermal conductivity of no more than 50 W/mK. In a preferred embodiment, the first thermally conductive filler A1 is selected from the group consisting of metal oxides, metal hydroxides, metal silicates, metal sulfides and combinations thereof.

Suitable metal oxides to be used as fillers A1 are preferably selected from the oxides of metals selected from the group consisting of tin, indium, antimony, aluminum, titanium, iron, magnesium, zinc, rare earth metals, alkaline metals, oxides of Mg, Ca, Sr and Ba, mixed metal oxides and mixtures thereof.

Suitable metal hydroxides to be used as fillers A1 are preferably selected from the hydroxides of metals selected from the group consisting of tin, indium, antimony, aluminum, titanium, iron, magnesium, zinc, rare earth metals, alkaline metals, hydroxides of Mg, Ca, Sr and Ba, mixed metal hydroxides and mixtures thereof.

Suitable metal silicates to be used as fillers A1 are preferably selected from the silicates of metals selected from the group consisting of tin, indium, antimony, aluminum, titanium, iron, magnesium, zinc, rare earth metals, alkaline metals, silicates of Mg, Ca, Sr and Ba, mixed metal silicates and mixtures thereof.

Suitable metal sulfides to be used as fillers A1 are preferably selected from the sulfides of metals selected from the group consisting of tin, indium, antimony, aluminum, titanium, iron, magnesium, zinc, rare earth metals, alkaline metals, sulfides of Mg, Ca, Sr and Ba, mixed metal sulfides and mixtures thereof.

In order to adapt the properties, in particular the thermal conductivity and the dispersibility of the filler, the material employed can be surface modified. In an especially preferred embodiment of the present invention, the filler A1 is therefore surface modified.

The second filler, filler A2, exhibits a thermal conductivity of at least 80 W/mK. In a preferred embodiment, the second filler A2 is selected from the group consisting of graphite, extended graphite, graphene, metal nitrides, metal flakes, metal oxides, carbon fibers, carbon nanotubes and combinations thereof. The metal oxides used as filler A2 preferably differ from the metal oxides used as filler A1.

Suitable metal nitrides to be used as fillers A2 in the present invention are preferably selected from the group of nitrides of metals selected from the group consisting of boron, tin, indium, antimony, aluminum, titanium, iron, magnesium, zinc, rare earth metals, alkaline metals, alkaline earth metals, silver, gold and mixtures and alloys thereof.

Suitable metal flakes to be used as fillers A2 in the present invention are preferably selected from the group consisting of tin, indium, antimony, aluminum, titanium, iron, magnesium, zinc, rare earth metals, alkaline metals, alkaline earth metals, silver, gold, mixtures thereof and alloys thereof.

A suitable metal oxide to be used as filler A2 in the present invention is, e.g. beryllium oxide (BeO).

The technical effect of the invention is achieved by the combination of a filler exhibiting a thermal conductivity of no more than 50 W/mK (A1) and a filler exhibiting a thermal conductivity of at least 80 W/mK (A2). Suitable fillers A1 can therefore be freely combined with suitable fillers A2.

In a particular preferred embodiment, filler A1 is present in component A in an amount of at least 10 wt.-%, preferably 30 wt.-% to 80 wt.-%, based on the total weight of component A.

In a preferred embodiment, the filler A2 is present in component A in an amount of at least 0.5 wt.-%, preferably 1 to 15 wt.-%, based on the total weight of component A.

It was surprisingly found that the thermal conductivity of the adhesive composition could be improved without substantially affecting the volume resistivity if the amount of filler A1 and/or filler A2 was kept within the above ranges.

Component A of the adhesive composition comprises a chain extender. Usually, chain extenders are low molecular weight molecules used to modify the backbone of a given polymer. In a preferred embodiment, the chain extender is a diol, in particular a linear or branched diol with 9 or less carbon atoms. In an especially preferred embodiment, the chain extender is selected from the group consisting of 1,2-propanediol, 1,3-propanediol, 2-methyl-1,3-propanediol, 1,4-butanediol, 1,5-pentanediol, 3-methyl-1,5-prentanediol, 1,6-hexanediol, 1,9-nonanediol, ethylene glycol, polyethylene glycol, neopentyl glycol, polybutylene glycol, cyclohexane-1,2-diol, cyclohexane-1,4-diol, 1,4-bis(hydroxymethyl)cyclohexane and mixtures thereof.

In a further preferred embodiment, the chain extender is present in component A in an amount of at least 0.1 wt.-%, preferably in an amount of 2 to 8 wt.-%, based on the total weight of component A. It was surprisingly found that the mechanical properties of the inventive adhesive composition could be adjusted as needed by varying the amount of chain extender in component A.

In a preferred embodiment, the polyol and the chain extender are present in component A in a weight ratio of 20:1 to 4:1, preferably 10:1 to 5:1.

### Component B

Component B of the inventive adhesive composition comprises at least one NCO-terminated compound. In a preferred embodiment of the invention, component B comprises an aliphatic or aromatic NCO-terminated compound and preferably a mixture of aromatic (poly)isocyanates and/or (poly)isocyanate prepolymers.

In a preferred embodiment, the NCO-terminated compound is selected from the groups consisting of 1,5-Naphthylendiisocyanate (NDI), 2,4′- or 4,4′-Diphenylmethandiisocyanate (MDI), Isomeres of Toluylendiisocyanates (TDI), Methylentriphenyltriisocyanate (MIT), hydrated MDI (H12MDI), Tetramethylxylylendiisocyanate (TMXDI), 1-Isocyanatomethyl-3-isocyanato-1,5,5-trimethylcyclohexane (IPDI), Xylylendiisocyanate (XDI), Hexan-1,6-diisocyanate (HDI), Pentamethylendiisocyanate, Dicyclohexylmethandiisocyanate as well as dimers, trimers, oligomers and polymers of the same.

Suitable (poly)isocyanate prepolymers are reactions products of compounds comprising OH groups and/or NH groups with an excess of polyisocyanates. Suitable prepolymers can for example be obtained by reacting a diol as described above with an excess of isocyanate as described above.

In an especially preferred embodiment, the NCO-terminated compound is a mixture of MDI isomers.

In a preferred embodiment, component B comprises at least 10 wt.-%, more preferably at least 25 wt.-% of the NCO-terminated compound, based on the total weight of component B. In an especially preferred embodiment, component B comprises 10 wt.-% to 90 wt.-%, in particular 25 wt.-% to 40 wt.-%, of the NCO-terminated compound.

The composition according to the invention may further comprise additives. These additives may be used to affect the properties of the composition, for example the mechanical properties and thermal conductivity. Preferably the one or more additives are selected from the group consisting of additional filler, pigments, rheology modifiers, drying agents, flame retardants, curing agents, surface active agents and anti-foaming agents.

In preferred embodiment the amount of additives present in component B is from 0 to 90 wt.-%, preferably 15 to 75 wt.-%, based on the total weight of the component B.

Apart from the thermal conductivity and the mechanical properties of the adhesive composition, other features have also to be taken into account, such as the processability. Especially the curability of the adhesive composition has to be adapted for the respective applications. It was surprisingly found that the mechanical properties of the inventive adhesive composition are advantageously balanced when the mixing ratio of component A to component B is within a certain range. Therefore, an embodiment of the present invention is preferred wherein the mixing ratio by weight of component A to component B is from 10:1 to 1:5, preferably 10:1 to 1:1,1, in particular 5:1 to 1:1.

In order to be processable in industrial application, the adhesive composition needs to have a viscosity that allows easy and precise application. Therefore, an embodiment is preferred wherein the adhesive composition according to the invention has a viscosity of no more than 10000 Pas, preferably no more than 1000 Pas, in particular 30 to 600 Pas, determined at 20° C.

The inventive adhesive composition is thermally conductive. In a preferred embodiment, the adhesive composition exhibits a thermal conductivity of at least 1 W/mK, preferably 1 to 3 W/mK, determined according to ISO 22007. It was surprisingly found that an advantageously balance between thermal conductivity and adhesiveness can be achieved if the thermal conductivity of the adhesive composition is chosen within the above ranges. Further, a thermal conductivity in the above range makes the adhesive composition especially suitable for use in the assemblies of energy storage devices.

A further object of the invention is cured adhesive composition obtainable by curing the adhesive composition according to the invention. Curing of the inventive adhesive composition can be carried out by usual methods well known to the person skilled in the art, such as treatment with radiation, for example UV light, exposure to moisture, induction or thermally.

Commonly, the thermal conductivity of an adhesive composition is achieved at the costs of the adhesive and mechanical properties of the adhesive. It was surprisingly found that the inventive cured adhesive composition not only exhibits excellent thermal conductivity, but also possess advantageous mechanical properties. The inventive cured adhesive composition thus combines thermal conductivity with good mechanical properties. In a preferred embodiment, the inventive cured adhesive composition exhibits a tensile elongation of at least 15%, preferably 20 to 200%, determined according to DIN EN ISO 527 at 23° C. It was surprisingly found that different expansion coefficient of different materials to be bonded could be balanced when the tensile elongation of the cured composition was within the claimed range.

In a further preferred embodiment, the inventive cured adhesive composition exhibits a tensile strength of at least 5 MPa, preferably 5 to 15 MPa, determined according to DIN EN ISO 527 at 23° C. It was surprisingly found that the cured composition showed a favorable cohesive strength when the values were chosen to lie within the claimed range.

According to a further preferred embodiment of the present invention, the cured adhesive composition exhibits a tensile modulus of no more than 500 MPa, preferably 10 to 100 MPa, determined according to DIN EN ISO 527 at 23° C. It was surprisingly found that the cured adhesive showed a flexibility that allows the absorbance of mechanical shocks without notably affecting the tensile strength if the tensile modulus was within the above range.

In a preferred embodiment, the cured adhesive composition exhibits a thermal conductivity of at least 1 W/mK, preferably 1 to 3 W/mK, determined according to ISO 22007.

The inventive adhesive composition is, in particular, suitable for use in the assembly of energy storage devices. It is therefore important that the cured adhesive composition does not show any significant electrical conductivity. In a preferred embodiment, the cured adhesive composition therefore possesses a high-volume resistivity, preferably more than 10⁹ Ωm, in particular more than 10¹⁰ Ωm, determined according to DIN EN 62631-3-1.

A further object of the present invention is a method for the manufacture of the inventive adhesive composition. The method according to the invention comprises the following steps:

a) providing component A and component B; and

b) mixing components A and B to obtain the adhesive composition.

In a preferred embodiment, the method according to the invention comprises the following steps:
a) providing at least on polyol having a molecular weight Mₙ of 700 to 12000 g/mol;
b) providing at least one chain extender having a molecular weight Mₙ of 60 to 600 g/mol;
c) providing at least one thermally conductive filler exhibiting a thermal conductivity of no more than 50 W/mK, determined according to ISO 22007;
d) providing at least one thermally conductive filler exhibiting a thermal conductivity of at least 80 W/mK, determined according to ISO 22007;
e) mixing the provided components to obtain component A; and
f) mixing component A with component B to obtain the adhesive composition.

A further object of the present invention is a method of manufacturing an article using the adhesive composition according to the invention. The method according to the invention comprises the following steps:
i) applying the adhesive composition according to the invention onto the surface of a first substrate to be bonded; and
ii) bringing the surface of the first substrate to be bonded, treated with the adhesive composition, into contact with a second substrate to be bonded; and
iii) curing the adhesive composition to obtain the desired article.

In a preferred embodiment, contacting of the first substrate to be bonded with the second substrate to be bonded is carried out by applying pressure.

The method according to the invention is especially suitable for the manufacture of temperature sensitive devices. In a preferred embodiment, the adhesive composition is therefore applied onto the surface of the first substrate at a temperature of 20 to 100° C., preferably 23 to 70° C.

A further object is an article obtainable according to method of manufacture according to the invention. Preferably, the article according to the invention comprises the cured adhesive composition according to the invention.

The adhesive composition according to the invention can be applied in a variety of technical fields and is especially suitable in the manufacture of heat sensitive objects, in particular objects where heat is generated. Accordingly, a further object of the present invention is the use of the inventive adhesive composition in pipes, preferably cooling coils; in electronic components, preferably light emitting devices, computer devices, mobile phones, tablets, touch screens, automotive technology, Wi-Fi systems, and audio systems; in joints between heat pipes and water tanks in solar heated heating; in fuel cell and wind turbines; in the manufacture of computer chips; in light devices; batteries; in housings; in coolers; heat exchanging devices; wires; cables; heating wires; household appliances such as refrigerators and dishwashers; air conditionings; accumulators; transformers; lasers; functional clothing; car seats; medical devices; fire protection; electric motors; planes and trains.

The invention will be illustrated in more detail by way of the following example which is not to be understood as limiting the concept of the invention.

### EXAMPLE 1

The following adhesive composition was prepared:

| Component A | Wt.-% |
|---|---|
| Polyol (4000 g/mol) | 23.9 |
| 3-Methyl-1,5-pentanediol | 3.8 |
| Graphite | 2.0 |
| Boron nitride | 5.0 |
| Aluminum oxide | 60.3 |
| Additives | 5.0 |

Modified isocyanate based in 4,4′-MDI was used as component B.

The composition showed a viscosity of 232 Pas, determined at 20° C. with Brookfield RVDV-II+P, spindle RV T-F, 10 rpm

The following properties were determined for the cured composition, determined at 23° C., respectively:

| | |
|---|---|
| Tensile modulus Eₜ [MPa] | 51 |
| Tensile strength max. σₘ [MPa] | 8.2 |
| Tensile elongation mach. εb [%] | 68 |
| Thermal conductivity [W/mK]¹ | 1.71 |

¹determined via Hot Disc Method

The cured composition showed a volume resistivity of 1.4*10¹⁰ Ωm, determined according to DIN EN 62631-3-1 at a temperature of 21.4° C. and a relative humidity of 46%.

Compositions comprising only one filler showed a decreased thermal conductivity, as apparent from the comparative examples shown below.

A composition according to Example 1 was prepared wherein graphite and boron nitride were omitted. The comparative composition contained 60.3 wt.-% of aluminum oxide as the filler in component A. The thermal conductivity of the composition after curing was determined to be 0.82 W/mK. Even increasing the amount of aluminum oxide to 67.3 wt.-% in component A only resulted in a slight increase in the thermal conductivity (0.97 W/mK).

Omitting the chain extender resulted in a composition which was not curable.

Comparative Examples wherein the filler A2 was omitted or substituted with the corresponding amount of filler A1 showed a remarkedly reduced thermal conductivity of the cured material. The thermal conductivity did not exceed 0.8 W/mK and 1.0 W/mK, respectively, compared to 1.7 W/mK of a corresponding inventive composition.

The same results were obtained when both fillers A1 and A2 were substituted by the corresponding amount of commonly used fillers such as CaCO₃ or MgCO₃. The thermal conductivity of the cured material in these cases was found to be only around 0.8 W/mK.

As can be seen, the present invention solves the assigned task as a good thermal conductivity can be achieved in combination with excellent mechanical properties.

1. A two component adhesive composition comprising a first component (A) and a separate second component (B), wherein component (A) comprises
a-1) at least one polyol having a molecular weight Mₙ of 700 to 12000 g/mol;
a-2) chain extender having a molecular weight Mₙ of 60 to 600 g/mol;
a-3) at least one thermally conductive filler A1 exhibiting a thermal conductivity of no more than 50 W/mK, determined according to ISO 22007; and
a-4) at least one thermally conductive filler A2 exhibiting a thermal conductivity of at least 80 W/mK, determined according to ISO 22007; and
wherein component (B) comprises at least one NCO-terminated compound.

2. The adhesive composition according to claim 1, wherein the conductive filler A1 is selected from the group consisting of metal oxide, metal hydroxide, metal silicate, metal sulfide and combinations thereof.

3. The adhesive composition according to claim 1, wherein the conductive filler A2 is selected from the group of graphite, extended graphite, graphene, metal nitride, metal flake, metal oxide, carbon fiber, carbon nanotube and combinations thereof.

4. The adhesive composition according to claim 1, wherein the ratio by mass of components A and B is 10:1 to 1:5.

5. The adhesive composition according to claim 1, wherein the polyol is a polyether polyol.

6. The adhesive composition according to claim 1, wherein the polyol is a polyether polyol comprising a mixture of primary and secondary hydroxyl groups.

7. The adhesive composition according to claim 1, wherein the chain extender is a diol selected from the group consisting of 1,2-propanediol, 1,3-propanediol, 2-methyl-1,3-propanediol, 1,4-butanediol, 1,5-pentanediol, 3-methyl-1,5-prentanediol, 1,6-hexanediol, 1,9-nonanediol, ethylene glycol, polyethylene glycol, neopentyl glycol, polybutylene glycol, cyclohexane-1,2-diol, cyclohexane-1,4-diol, 1,4-bis(hydroxymethyl)cyclohexane and mixtures thereof.

8. The adhesive composition according to claim 1, wherein component B comprises a mixture of aromatic (poly)isocyanates and/or aromatic (poly)isocyanate prepolymers.

9. The adhesive composition according to claim 1, wherein component B comprises an aliphatic or aromatic NCO-terminated compound.

10. The adhesive composition according to claim 1, wherein the filler A1 is present in an amount of 30 to 80 wt.-%, based in the total weight of component A.

11. The adhesive composition according to claim 1, wherein the filler A2 is present in an amount of at 0.5 wt.-%, 1 to 15 wt.-%, based on the total weight of component A.

12. Cured reaction products of the adhesive composition of claim 1.

13. Cured reaction products of the adhesive composition of claim 1, wherein the cured products exhibit a thermal conductivity of at least 1 W/mK, 1 to 3 W/mK, determined according to ISO 22007.

14. A method of manufacturing an article comprising at least two bonded substrates, the method comprising:
providing first and second substrates, each substrate having a respective surface to be bonded;
providing the component A and the component B of claim 1;
mixing components A and B together to obtain a mixed adhesive composition;
applying the mixed adhesive composition onto the first substrate surface to be bonded; and
bringing the second substrate surface to be bonded into contact with the applied adhesive on the first substrate to be bonded.

15. An article comprising the bonded first and second substrates of claim 14.

16. An article selected from a pipe, cooling coil; electronic component, light emitting device, computer device, mobile phone, tablet, touch screen, automobile, Wi-Fi system, audio system; joint between heat pipes and water tanks in a solar heating system; fuel cell, wind turbine; computer chip; light device; battery; housings; cooler; heat exchanging device; wire; cable; heating wire; household appliance; air conditioner; accumulator; transformer; laser; functional clothing; car seat; medical device; fire protection; electric motor, plane and train; comprising the two component adhesive composition of claim 1.
